(19) United States
(12) Patent Application Publication
(10) Pub. No.: US 2017/0304901 A1
(43) Pub. Date: Oct. 26, 2017

(54) APPARATUS FOR MAKING NANOPARTICLES AND NANOPARTICLE SUSPENSIONS

(71) Applicant: HRL LABORATORIES, LLC, Malibu, CA (US)

(72) Inventors: Randall C. Schubert, Santa Monica, CA (US); Tobias A. Schaedler, Oak Park, CA (US); John H. Martin, Ventura, CA (US)

(21) Appl. No.: 15/256,344

(22) Filed: Sep. 2, 2016

Related U.S. Application Data
(60) Provisional application No. 62/325,405, filed on Apr. 20, 2016.

(51) Int. Cl. B22F 9/14; B23H 1/02; B23H 1/10; B82Y 40/00; B23H 9/00

(52) U.S. Cl. CPC B22F 9/14; B82Y 40/00; B23H 9/001; B23H 1/10; B23H 1/02; B22F 2998/10; B22F 2201/11; B22F 2201/03; B22F 2201/02

(57) ABSTRACT

A wire explosion assembly configured to form nanoparticles by exploding at least a segment of an electrically conductive wire. The wire explosion assembly includes a spool supporting the electrically conductive wire, a vessel defining a wire explosion chamber, means in the wire explosion chamber for pulling the electrically conductive wire off of the spool and applying tension on the segment of the electrically conductive wire, and a power source for delivering an electrical current to the segment of the electrically conductive wire. The electrical current is configured to explode the segment of the electrically conductive wire into the nanoparticles.

### CROSS-REFERENCE TO RELATED APPLICATION(S)

This application claims priority to and the benefit of U.S. Provisional Patent Application No. 62/325,405, filed in the United States Patent and Trademark Office on Apr. 20, 2016, the entire contents of which are incorporated herein by reference.

### FIELD

The present disclosure relates generally to nanoparticles and, more specifically, the formation of nanoparticles.

### BACKGROUND

Nanoparticles exist in a variety of forms, including nanoparticles assembled on the surface of microparticles and nanoshells formed by coating nanoparticles on hollow microspheres. Additionally, nanoparticles are useful in a variety of applications, such as in coatings for combustion engines and exhaust systems or to activate sintering of bulk metallic parts. Nanoparticles are also useful in a variety of biological and medical applications.

Nanoparticles may be produced in a variety of methods, such as wire explosion, dry powder separation, and laser ablation. Wire explosion is a related art method that includes an instant capacitive discharge of a current through an electrically conductive wire, which explodes the wire to form the nanoparticles. However, in related art wire explosion methods, the wire is exploded in a nonflammable solvent, such as water, which reacts substantially with the nanoparticles upon their formation. This contamination from the reaction with the solvent reduces the quality and usefulness of the nanoparticles formed by this method. Similarly, related art femtosecond laser ablation methods are performed in a solvent, which results in contamination of the nanoparticles. Additionally, related art filtration methods, such as using air separators to filter particles by size, require the handling of dry powders, which presents a safety risk and a risk of contamination.

Many related art wire explosion methods also result in substantial downtime between wire explosion operations (i.e., a large off fraction of the duty cycle). For instance, some related art wire explosion methods include a limited number of discrete wire segments that are exploded successively in a stepwise manner. Furthermore, some related art wire explosion methods leave one end of the wire unconstrained during the explosion operation. Leaving one end of the wire unconstrained during explosion of the wire may cause reliability issues. For instance, nanoparticle size may vary between different wire explosion operations due to, for instance, variances in the length of the wire segment and/or variances in the tension applied to the wire segment during the wire explosion operation.

### SUMMARY

The present disclosure is directed to various embodiments of a wire explosion assembly configured to form nanoparticles by exploding at least a segment of an electrically conductive wire. In one embodiment, the wire explosion assembly includes a spool supporting the electrically conductive wire, a vessel defining a wire explosion chamber, means in the wire explosion chamber for pulling the electrically conductive wire off of the spool and applying tension on the segment of the electrically conductive wire, and a power source for delivering an electrical current to the segment of the electrically conductive wire. The electrical current is configured to explode the segment of the electrically conductive wire into the nanoparticles. The means for pulling and applying tension on the segment of the electrically conductive wire may include a wire clamping assembly rotatably housed in the wire explosion chamber. The wire clamping assembly may include a winding and tensioning member, at least first and second clamp assemblies coupled to the winding and tensioning member, and a wire guide coupled to the winding and tensioning member between the at least first and second clamp assemblies. The at least first and second clamp assemblies are each configured to move between a clamped position and a disengaged position. Rotation of the wire clamping assembly is configured to pull the segment of the electrically conductive wire into the wire explosion chamber and wind the segment of the electrically conductive wire around at least a portion of winding and tensioning member to apply the tension to the segment of the electrically conductive wire. When the at least first and second clamp assemblies are in the clamped position, the segment of the electrically conductive wire extends between the wire guide and one of the at least first and second clamp assemblies. The wire explosion assembly may also include a first electrical wire coupled to the first clamp assembly, a second electrical wire coupled to the second clamp assembly, and a third electrical wire coupled to the wire guide. The power source is coupled to the first and second electrical wires and the power source is configured to alternately deliver the current through the first and second clamp assemblies to the segment of the electrically conductive wire to explode the segment of the electrically conductive wire into the nanoparticles. The first and second electrical wires may each have a first polarity and the third electrical wire may have a second polarity opposite the first polarity. The wire explosion assembly may also include a motor coupled to the wire clamping assembly that is configured to rotate the wire clamping assembly in the wire explosion chamber. The vessel may include an inwardly-facing cam surface having at least one lobe and the first and second clamp assemblies may each include a roller engaging the cam surface. The engagement between the rollers and the at least one lobe on the cam surface of the vessel is configured to alternately move the first and second clamp assemblies into the disengaged position. The wire explosion assembly may include an inlet opening defined in the vessel and a wire feed guide housed in the wire explosion chamber. The inlet opening is configured to receive the electrically conductive wire extending into the wire explosion chamber. The wire feed guide is configured to align the electrically conductive wire with the wire clamping assembly. The at least one lobe on the inwardly-facing cam surface may be positioned proximate to the inlet opening and the wire feed guide. During the rotation of the wire clamping assembly, the first and second clamping assemblies may engage the at least one lobe before reaching the inlet opening. Each of the first and second clamp assemblies may also include a resilient member configured to bias the first and second clamp assemblies into the clamped position. The wire explosion assembly may include first and second wire guides coupled to the winding and tensioning member and located between the first and second clamp assemblies. The winding and tensioning member may include an electrically non-conductive material.

The present disclosure is also directed to various embodiments of a system configured to form a nanoparticle suspension. In one embodiment, the system includes a wire explosion assembly configured to form nanoparticles by exploding at least a segment of an electrically conductive wire and a gas flow system configured to introduce a first processing gas into a wire explosion chamber. The wire explosion assembly may include a spool supporting the electrically conductive wire, a vessel defining the wire explosion chamber, means in the wire explosion chamber for pulling the electrically conductive wire off of the spool and applying tension on the segment of the electrically conductive wire, and a power source for delivering an electrical current to the segment of the electrically conductive wire. The electrical current is configured to explode the segment of the electrically conductive wire into the nanoparticles. The first processing gas may be any suitable gas or combination or gases, such as oxygen, nitrogen, and/or argon. The system may include a liquid in the wire explosion chamber, and the means for pulling and applying tension on the segment of the electrically conductive wire may be submerged in the liquid such that the nanoparticles are formed in the liquid. The system may also include a bubbler system coupled to the wire explosion assembly that is configured to introduce a solvent to the nanoparticles to form the nanoparticle suspension. The system may also include a post-processing apparatus positioned between the wire explosion assembly and the bubbler system. The post-processing apparatus may be configured to introduce a second processing gas different than the first processing gas. The post-processing apparatus may be configured heat the nanoparticles, cool the nanoparticles, expose the nanoparticles to an electromagnetic field, expose the nanoparticles to radiation, increase a pressure on the nanoparticles, and/or decrease a pressure on the nanoparticles.

The present disclosure is also directed to various methods of forming nanoparticles. In one embodiment, the method includes pulling a segment of an electrically conductive wire into a wire explosion chamber, applying a substantially constant tension to the segment of the electrically conductive wire, and delivering an electrical current to the segment of the electrically conductive wire while applying the substantially constant tension to the segment of the electrically conductive wire to form the nanoparticles.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

Embodiments of apparatuses for making nanoparticles and/or nanoparticle suspensions according to the present disclosure are described with reference to the following figures. The same reference numerals are used throughout the figures to reference like features and components. The figures are not necessarily drawn to scale.

FIG. 1 is a schematic view of a system for making nanoparticle suspensions including a wire explosion assembly according to one embodiment of the present disclosure;

FIGS. 2A and 2B are a side view and a cross-sectional view, respectively, of the embodiment of the wire explosion assembly illustrated in FIG. 1 including a rotatable wire clamping assembly; and

FIGS. 3A-3D are perspective views of the embodiment of the wire clamping assembly illustrated in FIGS. 2A and 2B in four different angular positions during a wire explosion operation.

### DETAILED DESCRIPTION

The present disclosure is directed to various embodiments of an apparatus for forming nanoparticles and/or nanoparticle suspensions by a wire explosion technique. In one or more embodiments, the apparatus is configured to form uniform or substantially uniform nanoparticles. Additionally, in one or more embodiments, the apparatus is configured to form the nanoparticles and then directly introduce the nanoparticles into a desired solvent to produce a nanoparticle suspension. The direct introduction of the nanoparticles into the solvent is configured to form nanoparticle suspensions having a high degree of purity with minimal or no surface contamination. Furthermore, in one or more embodiments, the apparatus is configured to form nanoparticles in a continuous or substantially continuous manner with repeatability in the size and quality of the nanoparticles. Moreover, in one or more embodiments, the apparatus is configured to maintain the wire in constant or substantially constant tension throughout the wire explosion technique, which is configured to aid in the formation uniform or substantially uniform nanoparticles.

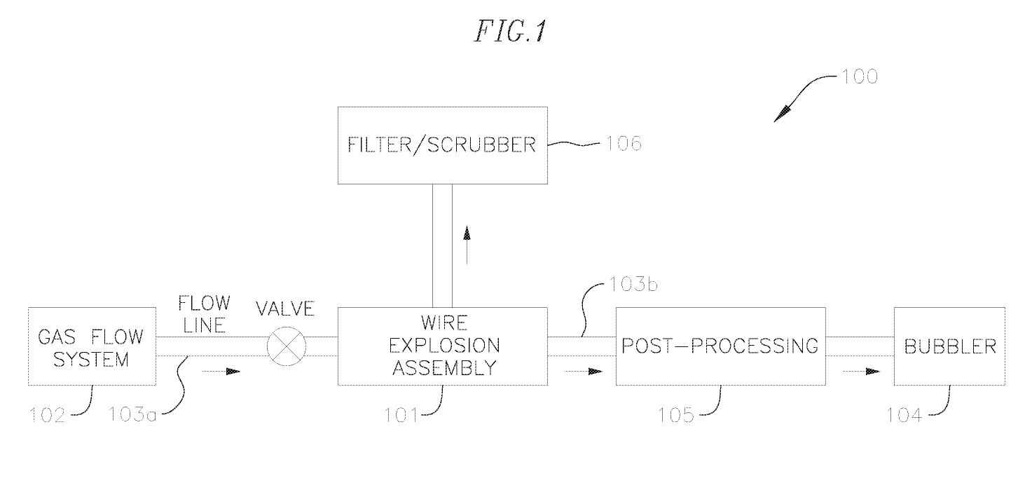

FIG. 1 depicts a schematic view of a system 100 configured to form nanoparticles and/or nanoparticle suspensions according to one embodiment of the present disclosure. In the illustrated embodiment, the system 100 includes a wire explosion assembly 101 configured to form nanoparticles, a gas flow system 102 configured to deliver one or more processing gases through at least one flow line 103a to the wire explosion assembly 101, and a bubbler 104 configured to introduce a solvent to the nanoparticles to form a nanoparticle suspension. In one or more embodiments, the system 100 may also include at least one post-processing apparatus 105 and/or a filter (e.g., a scrubber) apparatus 106 for removing and/or treating exhaust gases from the wire explosion assembly 101.

The gas flow system 102 and the at least one flow line 103a are configured to deliver the one or more process gases to the wire explosion assembly 101 with a flowrate suitable to maintain the proper stoichiometry of the nanoparticles. The process gas may be any suitable gas depending on the desired effect on the nanoparticles, such as, for instance, oxygen to form an oxide or nitrogen to form a nitride. Additionally, in one or more embodiments, the gas flow system 102 may be configured to deliver two or more gasses to the wire explosion assembly 101. In one or more embodiments, the gas flow system 102 may be configured to deliver one or more inert gases, such as argon, to assist in moving the nanoparticles through the system 100.

With continued reference to the embodiment illustrated in FIG. 1, the bubbler 104 is configured to introduce a solvent to the nanoparticles and to produce bubbles to suspend the nanoparticles. In one or more embodiments, the bubbler 104 is air and moisture tight. The bubbler 104 may be configured to introduce the solvent with or without exposure to the atmosphere. In one or more embodiments, the system 100 may include two or more bubblers 104 arranged in series or parallel to trap a greater number of nanoparticles in the bubbles produced by the bubbler 104 and/or to control the gas pressure leaving the flow lines. The bubbler 104 may be any suitable type of bubbler, such as, for instance, a relatively simple bubbler including a tube submerged in a volume of solvent or a relatively more complex bubbler including a diffuser configured to generate smaller bubbles and thereby suspend (i.e., trap) a greater number of nanoparticles. In one or more embodiments, the bubbler 104 may be configured to produce a more complicated flow pattern to increase nanoparticle trapping, such as, for instance, by cascading the solvent and/or inducing ultrasonic agitation of the solvent.

Still referring to the embodiment illustrated in FIG. 1, the post-processing apparatus 105 defines at least one post-processing chamber that may be used to introduce one or more additional processing gases into the nanoparticles and/or to expose the nanoparticles to one or more conditions prior to sending the nanoparticles to the bubbler 104 for the production of the nanoparticle suspension. Any suitable processing gases, conditions, or combinations thereof may be performed on the nanoparticles by the post-processing apparatus 105 depending on the desired characteristics and properties of the nanoparticles and the intended application of the nanoparticles. In one embodiment in which the post-processing apparatus 105 is configured to introduce a new processing gas to the nanoparticles (e.g., a processing gas different than the processing gas introduced into the wire explosion assembly 101 by the gas flow system 102), the post-processing apparatus 105 may be configured to monitor and control the back pressure from the bubbler 104. Additionally, in one or more embodiments, the post-processing apparatus 105 may be configured to shut off the flow of nanoparticles from the wire explosion assembly 101 (e.g., a flow line 103b extending between the wire explosion assembly 101 and the post-processing apparatus 105 may include a valve) such that, for instance, the post-processing apparatus 105 may perform one or more tasks on the nanoparticles that require longer processing time than the flowrate of the nanoparticles from the wire explosion assembly 101 would permit. Following the post-processing of the nanoparticles in the post-processing apparatus 105, the post-processing apparatus 105 may be configured to reinitiate the flow of nanoparticles from the wire explosion assembly 101 to the post-processing apparatus 105 and to permit the post-processed nanoparticles to flow into the bubbler 104. In one or more embodiments, the post-processing apparatus 105 may be configured to introduce a catalyst prior to introducing one or more processing gases. The post-processing apparatus 105 may be configured to introduce the catalyst into the post-processing apparatus 105 and/or into the flow line 103b leading into the post-processing apparatus 105. The catalyst may be configured to remove and/or deactivate the processing gas introduced into the wire explosion assembly 101 such that the processing gas introduced in the post-processing apparatus 105 does not cross-react with the processing gas introduced in the wire explosion assembly 101.

Additionally, in one or more embodiments, the post-processing apparatus 105 may be configured to heat the nanoparticles to an elevated temperature, cool the nanoparticles to a reduced temperature, expose the nanoparticles to an electromagnetic field and/or radiation, and/or to increase or decrease the pressure of the nanoparticles. The post-processing apparatus 105 may include a single post-processing chamber or multiple post-processing chambers. Accordingly, the tasks described above may be performed sequentially in a single post-processing chamber or sequentially in multiple post-processing chambers. Additionally, in one or more embodiments, the post-processing apparatus 105 may be configured to process the nanoparticles in a closed-loop manner prior to introducing the nanoparticles into the bubbler 104. Furthermore, in one or more embodiments, the post-processing apparatus 105 may be under a vacuum (e.g., one or more of the post-processing chambers of the post-processing apparatus 105 may be a vacuum chamber) such that the post-processing apparatus 105 is configured to aid in drawing the nanoparticles from the wire explosion assembly 101. In one or more alternate embodiments, the system 100 may be provided without the post-processing apparatus 105.

Additionally, in one or more embodiments, the system 100 may be configured to form a dry nanoparticle powder rather than a nanoparticle suspension. In one or more embodiments, the system 100 may include one or more mechanisms configured to collect the dry nanoparticle powder, such as, for instance, a settling mechanism, a filtration mechanism, and/or a static attraction mechanism.

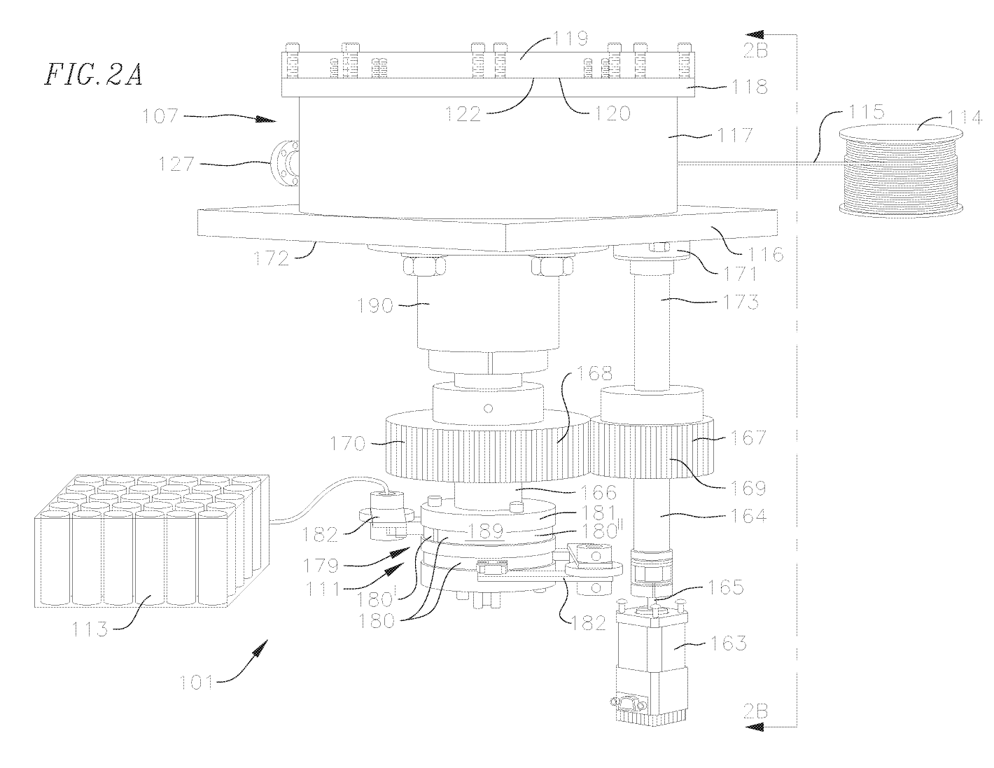

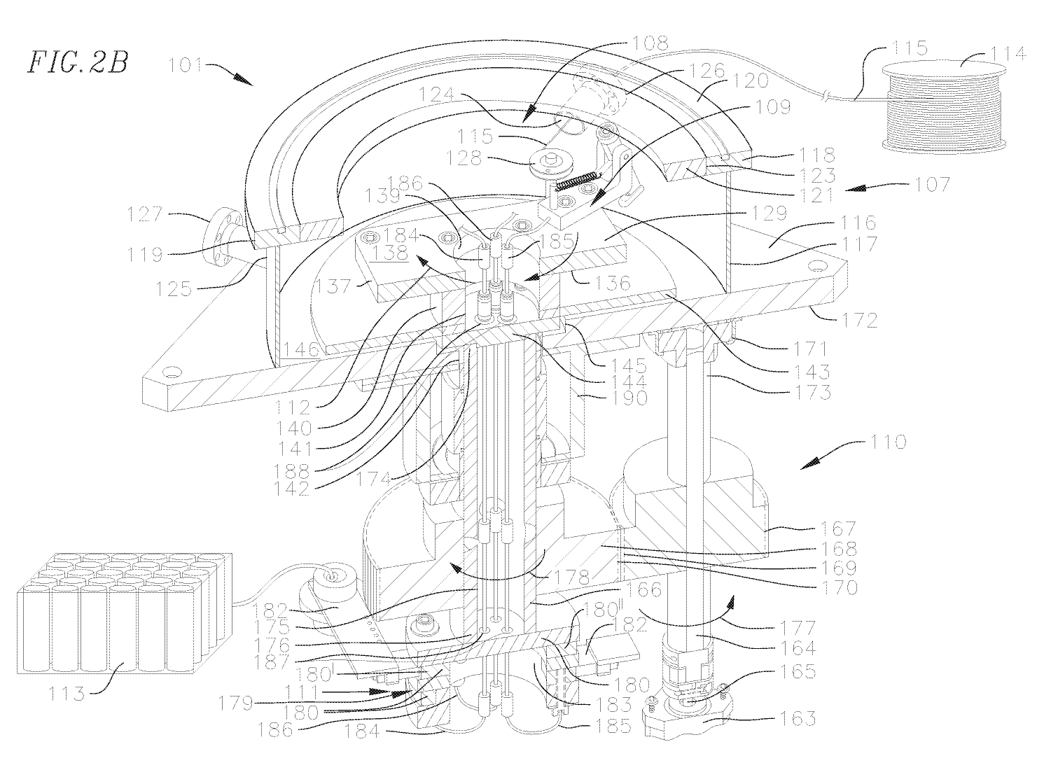

With reference now to FIGS. 2A-2B, the wire explosion assembly 101 according to one embodiment of the present disclosure includes a wire explosion vessel 107 defining a wire explosion chamber 108, a wire clamping assembly 109 housed in the wire explosion chamber 108, a rotary drive assembly 110 coupled to the wire clamping assembly 109, and a brush and slip ring assembly 111 coupled to the rotary drive assembly 110. The rotary drive assembly 110 is configured to rotate (arrow 112) the wire clamping assembly 109 in the wire explosion chamber 108. The wire explosion assembly 101 also includes a power source 113 (e.g., a capacitive discharge bank) electrically coupled to brush and slip ring assembly 111 and the wire clamping assembly 109. The wire explosion assembly 101 also includes a spool 114 outside of the wire explosion chamber 108 around which electrically conductive wire 115 is wound. As described in more detail below, the rotation (arrow 112) of the wire clamping assembly 109 is configured to draw at least a segment of the electrically conductive wire 115 from the spool 114 and into the wire explosion chamber 108. The current supplied by the power source 113 to the wire clamping assembly 109 and a segment of the electrically conductive wire 115 secured to the wire clamping assembly 109 is configured to explode the segment of the electrically conductive wire 115 into a series of nanoparticles. In one or more embodiments, the power source 113 may include one or more capacitors having an electrical potential from approximately 1 kV to approximately 1 MV and a capacitance from approximately (about) 0.000001 Farad to approximately (about) 1000 Farads. The current supplied from the power source 113 to the segment of the electrically conductive wire 115 may be selected depending, for instance, on the characteristics of the electrically conductive wire 115 (e.g., the diameter, length, and/or material of the segment of the electrically conductive wire 115). Additionally, in one or more embodiments, the discharge of the current through the segment of the electrically conductive wire 115 may occur from within approximately (about) 1 nanosecond (“ns”) to approximately (about) 100 microseconds (“μs”).

With continued reference to the embodiment illustrated in FIGS. 2A-2B, the wire explosion vessel 107 includes a base 116, a sidewall 117 (e.g., a cylindrical sidewall) extending up from the base 116, an upper lip or flange 118 (e.g., an annular lip or flange) connected to an upper end of the sidewall 117, a cover 119 configured to be detachably coupled to an upper surface 120 of the upper lip 118 (e.g., by a plurality of fasteners), and a cam 121 coupled to a lower surface 122 of the cover 119. In the illustrated embodiment, the cam 121 is configured to contact an inner surface 123 of the upper lip 118 when the cover 119 is coupled to the upper lip 118. Together, the base 116, the sidewall 117, the upper lip 118, and the cover 119 define the wire explosion chamber 108. In the illustrated embodiment, the wire explosion chamber 108 also defines an inlet opening 124 and an outlet opening 125. In the illustrated embodiment, the inlet and outlet openings 124, 125 are defined in the sidewall 117 of the wire explosion vessel 107. Additionally, in the illustrated embodiment, the wire explosion assembly 101 includes an inlet conduit 126 extending to the inlet opening 124 and an outlet conduit 127 extending from the outlet opening 125. The electrically conductive wire 115 is configured to extend from the spool 114 outside of the wire explosion chamber 108 into the wire explosion chamber 108 through the inlet conduit 126 and the inlet opening 124. Additionally, in the illustrated embodiment, the wire explosion assembly 101 includes a wire feed guide 128 housed in the wire explosion chamber 108. The electrically conductive wire 115 extends into the wire explosion chamber 108 through the inlet conduit 126 and the inlet opening 124 and around at least a portion of the wire feed guide 128. The wire feed guide 128 is configured to properly align the electrically conductive wire 115 with the wire clamping assembly 109.

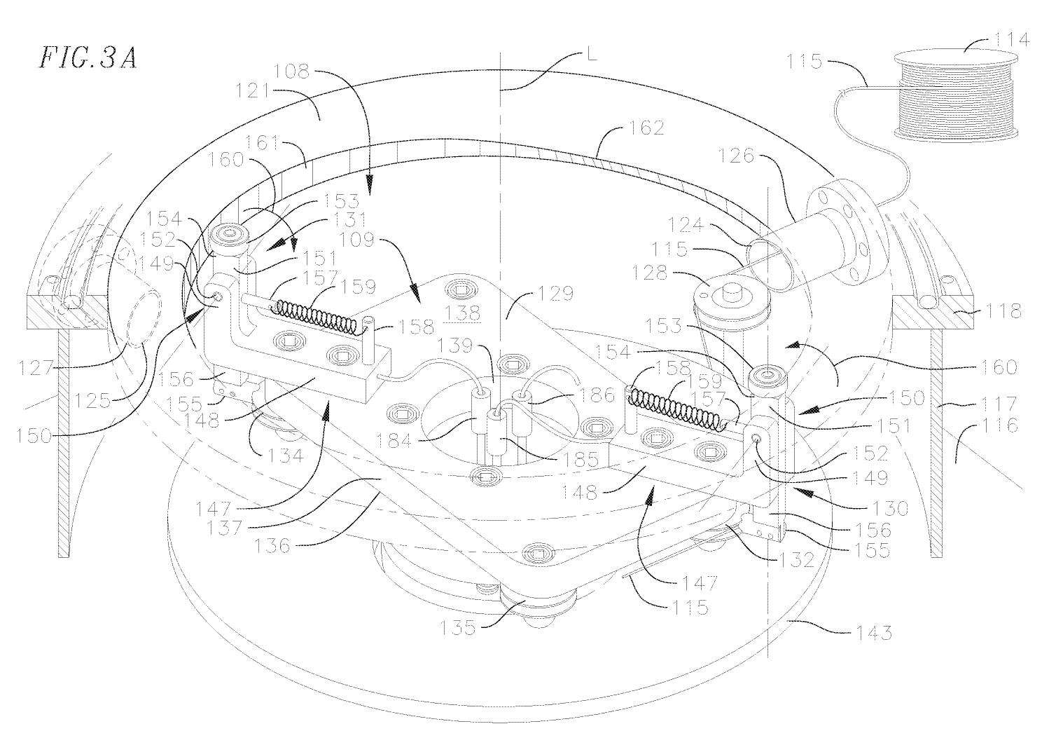

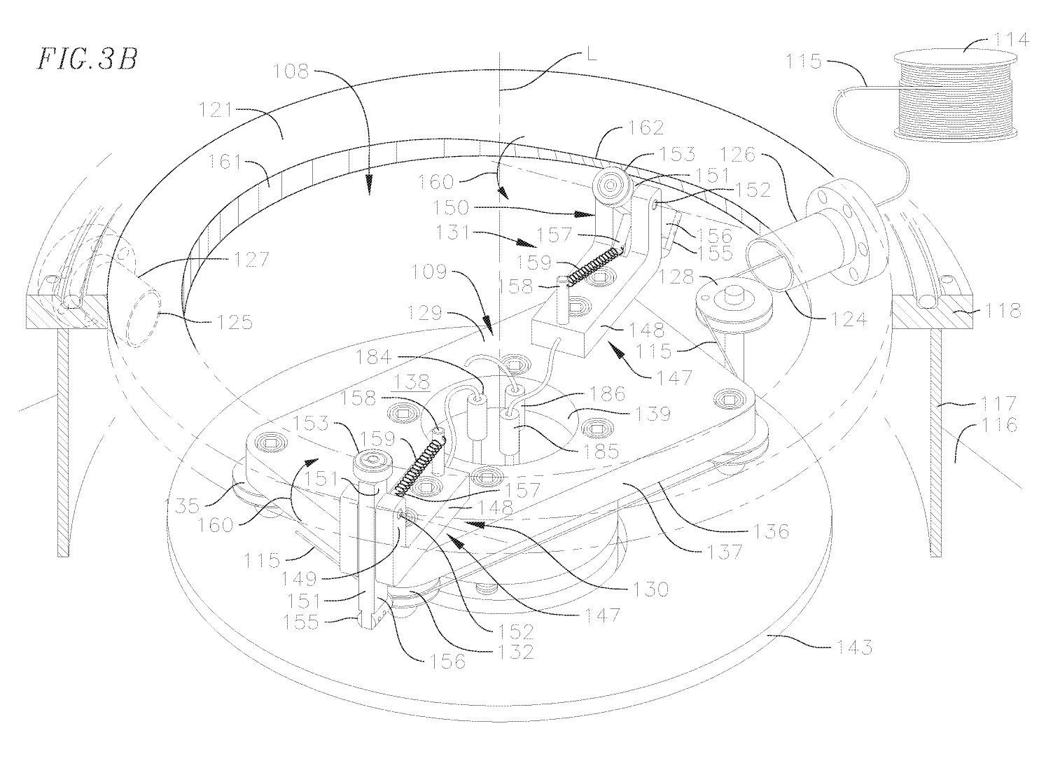

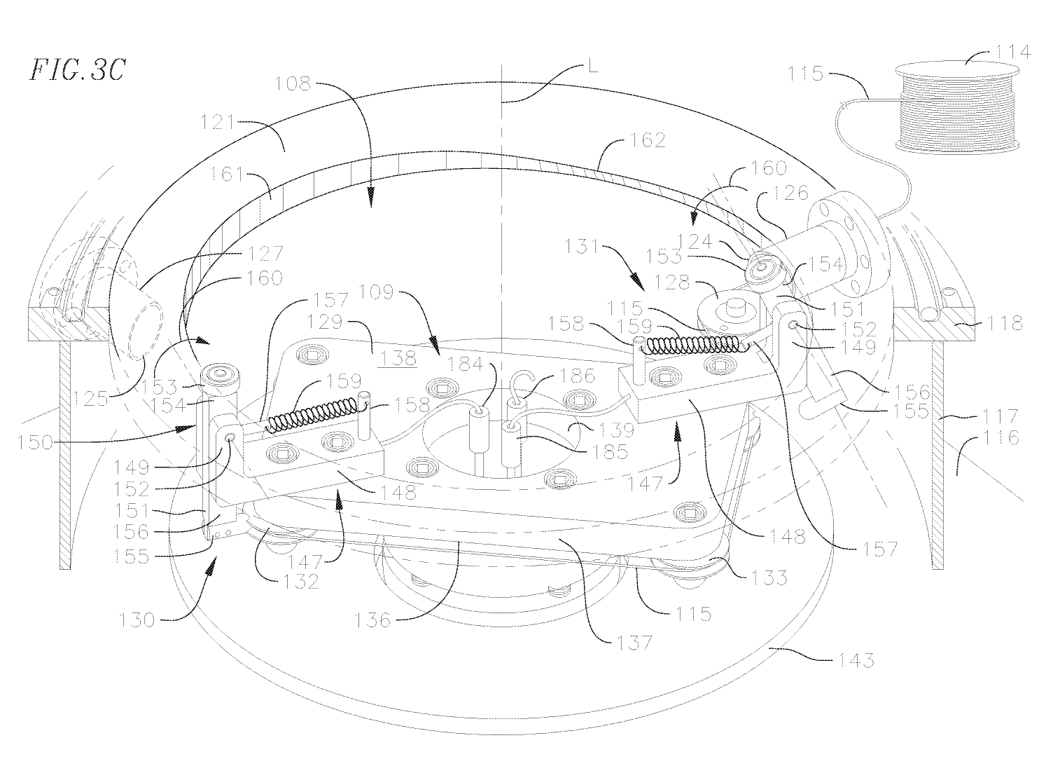

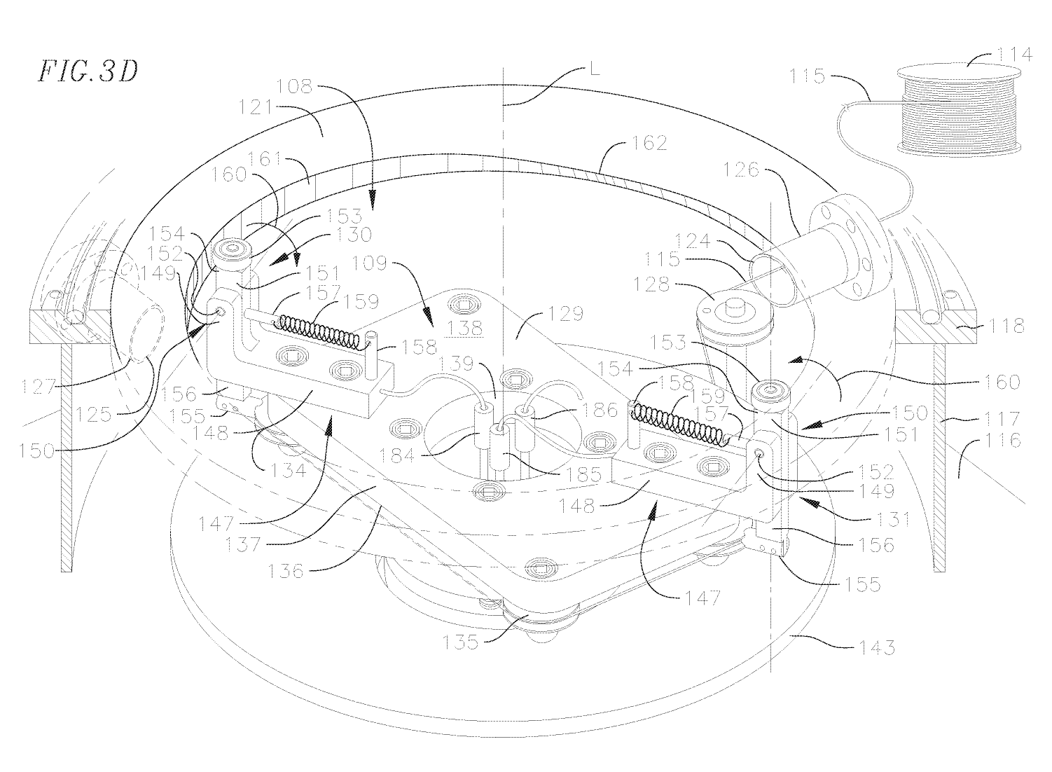

With reference now to the embodiment illustrated in FIGS. 2A-3A the wire clamping assembly 109 includes a winding and tensioning member 129, first and second clamp assemblies 130, 131 coupled to the winding and tensioning member 129, and a plurality of wire guides 132, 133, 134, 135 (e.g., first, second, third, and fourth wire guides) coupled to the winding and tensioning member 129. In the illustrated embodiment the winding and tensioning member 129 is a rectangular plate and the first and second clamp assemblies 130, 131 are located at diagonally opposed corners of the winding and tensioning member 129 and the wire guides 132, 133, 134, 135 are located at each of the four corners of the winding and tensioning member 129. In one or more alternate embodiments, the winding and tensioning member 129 may have any other suitable shape and the first and second clamp assemblies 130, 131 and the wire guides 132, 133, 134, 135 may be arranged in any other suitable configuration on the winding and tensioning member 129. Additionally, in one or more embodiments, the wire clamping assembly 109 may include any other suitable number of clamp assemblies 130, 131, such as, for instance, three or more clamp assemblies, and any other suitable number of wire guides 132, 133, 134, 135 depending, for instance, on the shape and/or size of the winding and tensioning member 129. Additionally, in the illustrated embodiment, the clamp assemblies 130, 131 and the wire guides 132, 133, 134, 135 are electrically conductive and the winding and tensioning member 129 is electrically non-conductive. In one or more embodiments, the winding and tensioning member 129 may be electrically conductive and the winding and tensioning member 129 may be electrically isolated from the clamp assemblies 130, 131 such as, for instance, by one or more rubber gaskets. Additionally, in the illustrated embodiment, two of the wire guides 132, 134 are aligned with the clamp assemblies 130, 131 and the other two wire guides 133, 135 are located between the clamp assemblies 130, 131.

In the illustrated embodiment, the wire guides 132, 133, 134, 135 are rollers, although in one or more embodiments the wire guides 132, 133, 134, 135 may have any other suitable configuration. In the illustrated embodiment, the wire guides 132, 133, 134, 135 are coupled to a lower surface 136 of the winding and tensioning member 129, although in one or more alternate embodiments, the wire guides 132, 133, 134, 135 may be coupled to any other portion of the winding and tensioning member 129, such as, for instance, one or more of sidewalls 137 or an upper surface 138 of the winding and tensioning member 129. Furthermore, in the illustrated embodiment, the wire guides 132, 133, 134, 135 are coupled to the winding and tensioning member 129 by fasteners extending down through the winding and tensioning member 129.

Additionally, in the illustrated embodiment, the winding and tensioning member 129 defines a central opening 139. In the illustrated embodiment, the wire clamping assembly 109 also includes a standoff 140 supporting the winding and tensioning member 129. The standoff 140 spaces the winding and tensioning member 129 apart from the base 116 of the wire explosion vessel 107. In the illustrated embodiment, the standoff 140 is a hollow member defining a central opening 141 aligned with the central opening 139 in the winding and tensioning member 129 and a central opening 142 defined in the base (or base plate) 116 of the wire explosion vessel 107. In the illustrated embodiment, the wire clamping assembly 109 also includes a lower cover 143 and a junction plate 144. The standoff 140 is supported on a portion of the lower cover 143 and extends upward from the lower cover 143. A portion of the lower cover 143 is supported on the junction plate 144 such that a portion of the lower cover 143 is between the standoff 140 and the junction plate 144. In the illustrated embodiment, the junction plate 144 is received in a recess 145 defined in the base plate 116 such that the lower cover 143 is flush or substantially flush with an upper surface 146 of the base plate 116. The lower cover 143 extends radially outward from the standoff 140 and the junction plate 144 and covers the recess 145 and the central opening 142 in the base plate 116. Accordingly, the lower cover 143 is configured to prevent nanoparticles formed in the wire explosion chamber 108 from escaping through the central opening 142 in the base plate 116.

With continued reference to the embodiment illustrated in FIGS. 2A-3A, each of the clamp assemblies 130, 131 includes an L-shaped support bracket 147 coupled to the winding and tensioning member 129. In the illustrated embodiment, each L-shaped bracket 147 includes a horizontal leg 148 coupled to the upper surface 138 of the winding and tensioning member 129 and a vertical leg 149 extending upward from the horizontal leg 148. In the illustrated embodiment, the vertical leg 149 of the L-shaped support bracket 147 is bifurcated such that the vertical leg 149 defines a clevis 150. Additionally, in the illustrated embodiment, each clamp assembly 130, 131 includes a lever 151 pivotally coupled to the clevis 150 defined in the vertical leg 149 of the support bracket 147 by a clevis pin 152. In the illustrated embodiment, each clamp assembly 130, 131 also includes a roller 153 coupled to an upper end 154 of the lever 151 and a clamp 155 coupled to a lower end 156 of the lever 151. In the illustrated embodiment, the clamp 155 is a pin-shaped member. In one or more embodiments, the clamps 155 of the clamp assemblies 130, 131 may have any other suitable shape. Although in the illustrated embodiment the roller 153 is cylindrical, in one or more alternate embodiments, the roller 153 may have any other suitable shape, such as, for instance, spherical. The rollers 153 of the clamp assemblies 130, 131 contact the cam 121, the significance of which is described below.

In the illustrated embodiment, each clamp assembly 130, 131 includes a horizontal pin 157 extending inward from the lever 151, a vertical pin 158 extending upward from the horizontal leg 148, and a resilient member 159 (e.g., a spring) extending between and coupled to the horizontal and vertical pins 157, 158. The lever 151 and the clamp 155 coupled to the lever 151 are configured to move (e.g., pivot or rotate) (arrow 160) between an engaged position and a disengaged position, the significance of which is described below. The resilient member 159 is configured to bias the lever 151 and the clamp 155 into the engaged position.

Still referring to the embodiment illustrated in FIGS. 2A-2B, the cam 121 is housed in the wire explosion chamber 108 and includes an inwardly-facing cam surface 161 (i.e., the cam surface 161 faces inward toward a longitudinal axis L of the wire explosion vessel 107). Additionally, in the illustrated embodiment the cam 121 includes a lobe 162. A portion of the cam surface 161 at the lobe 162 extends further inward toward the longitudinal axis L of the wire explosion vessel 107 than a remaining portion of the cam surface 161. Additionally, in the illustrated embodiment, the portion of the cam surface 161 at the lobe 162 is canted (e.g., sloped or angled) inward toward the longitudinal axis L of the wire explosion vessel 107 and the remainder of the cam surface 161 is parallel or substantially parallel with the longitudinal axis L of the wire explosion vessel 107 (e.g., the remainder of the cam surface 161 is vertical or substantially vertical).

In one or more alternate embodiments, the entire cam surface 161 may be parallel or substantially parallel with the longitudinal axis L of the wire explosion vessel 107 (e.g., the entire cam surface 161 may be vertical or substantially vertical). As described in more detail below, the cam surface 161 of the cam 121 is configured to move (e.g., pivot or rotate) (arrow 160) the clamp assemblies 130, 131 between the engaged and disengaged positions.

With continued reference to the embodiment illustrated in FIGS. 2A-2B, the rotary drive assembly 110 includes a drive motor 163, a drive shaft 164 coupled to an output shaft 165 of the drive motor 163, and a transmission member 166 coupled to the drive shaft 164. Additionally, in the illustrated embodiment, the rotary drive assembly 110 includes a drive gear 167 coupled to the drive shaft 164 and a transmission gear 168 coupled to the transmission member 166. Teeth 169 on the drive gear 167 are engaged (e.g., meshed) with teeth 170 on the transmission gear 168. Additionally, in the illustrated embodiment, the rotary drive assembly 110 includes a rotary bearing 171 coupled to a lower surface 172 of the base 116 of the wire explosion vessel 107. An upper end 173 of the drive shaft 164 is rotatably received in the rotary bearing 171.

In the illustrated embodiment, the transmission member 166 extends up into the central opening 142 of the base 116 of the wire explosion vessel 107 and an upper end 174 of the transmission member 166 is coupled to junction plate 144 of the wire clamping assembly 109. In the illustrated embodiment, the transmission member 166 is a hollow member defining a central axial opening 175. The central axial opening 175 extends from a lower end 176 to the upper end 174 of the transmission member 166. When the drive motor 163 is actuated, the drive motor 163 rotates (arrow 177) the drive shaft 164 and the drive gear 167. Additionally, because the drive gear 167 is engaged with the transmission gear 168, the rotation (arrow 177) of the drive gear 167 causes the transmission gear 168 and the transmission member 166 to rotate (arrow 178). The rotation (arrow 178) of the transmission member 166 causes the wire clamping assembly 109 to rotate (arrow 112) inside the wire explosion chamber 108. The relative sizes of the drive gear 167 and the transmission gear 168 may be selected based on the desired gear ratio and the desired rotation rate of the wire clamping assembly 109 in the wire explosion chamber 108.

Additionally, in the illustrated embodiment, the brush and slip ring assembly 111 is coupled to the lower end 176 of the transmission member 166. In the illustrated embodiment, the brush and slip ring assembly 111 includes a slip ring drum 179 having a stack of slip rings 180 and a cap plate 181 on top of the stack of slip rings 180. The brush and slip ring assembly 111 also includes a pair of brushes 182 (e.g., carbon brushes) contacting the slip rings 180. In the illustrated embodiment, the slip ring drum 179 is hollow and defines a central opening 183. Additionally, in the illustrated embodiment, the slip ring 180 that is contacted (e.g., engaged) by the brushes 182 is a split ring including two semi-annular components 180′, 180″, the significance of which is described below.

In the illustrated embodiment, the wire explosion assembly 101 includes a series of electrical wires 184, 185, 186 coupled to the slip rings 180. In the illustrated embodiment, the electrical wire 184 is coupled to the first semi-annular component 180′ of one of the slip rings 180 and the electrical wire 185 is coupled to the second semi-annular component 180″ of the slip ring 180. The electrical wires 184, 185, 186 extend up through the central opening 183 of the slip ring drum 179, through one or more openings 187 defined in the cap plate 181, up through the central axial opening 175 of the transmission member 166, through one or more openings 188 defined in the junction plate 144, and up through the central openings 141, 139 in the standoff 140 and the winding and tensioning member 129, respectively, of the wire clamping assembly 109. Additionally, upper ends of the electrical wires 184, 185, 186 are coupled to the wire clamping assembly 109. For instance, in the illustrated embodiment, the electrical wire 184 is coupled to the first clamp assembly 130, the electrical wire 185 is coupled to the second clamp assembly 131, and the electrical wire 186 is coupled to the wire guides 133, 135 that are located between the clamp assemblies 130, 131 (i.e., the electrical wire 186 is coupled to the wire guides 133, 135 that are not aligned with the clamp assemblies 130, 131). Additionally, in the illustrated embodiment, the electrical wire 186 coupled to the wire guides 133, 135 has the opposite polarity as the electrical wires 185, 186 coupled to the clamp assemblies 130, 131. For instance, in one or more embodiments, the electrical wires 184 and 185 may have a positive polarity (e.g., the electrical wires 184 and 185 may be anodes) and the electrical wire 186 may have a negative polarity (e.g., the electrical wire 186 may be a cathode). In one or more embodiments, the electrical wires 184 and 185 may have a negative polarity and the electrical wire 186 may have a positive polarity. Additionally, in the illustrated embodiment, the power source (supply) 113 (e.g., the capacitive discharge bank) is coupled to the brushes 182 of the brush and slip ring assembly 111. The brush and slip ring assembly 111 is configured to permit current to be transmitted to the electrical wires 184, 185, 186 housed within the transmission member 166 while the transmission member 166 and the electrical wires 184, 185, 186 housed therein are rotating (arrow 178). That is, as the slip ring drum 179, the transmission member 166, and the wire clamping assembly 109 rotate (arrows 178, 112), the brushes 182 maintain contact with an outer surface 189 of the stack of slip rings 180 to transmit current through the slip rings 180 and to the electrical wires 184, 185, 186 coupled to the slip rings 180.

Additionally, in the illustrated embodiment, the rotary drive assembly 110 includes a sealed rotary passthrough 190 coupled to the lower surface 172 of the base 116 of the wire explosion vessel 107. The transmission member 166 and the electrical wires 184, 185, 186 housed in the transmission member 166 extend up through the sealed rotary passthrough 190. The sealed rotary passthrough 190 is configured to create a hermetic seal to prevent or mitigate the risk of nanoparticles formed in the wire explosion chamber 108 from inadvertently escaping from the wire explosion chamber 108 through the central opening 142 in the base 116 of the wire explosion vessel 107. The sealed rotary passthrough 190 may include any suitable type or kind of sealing mechanism, such as, for instance, a magnetic liquid sealing mechanism using a ferrofluid.

FIGS. 3A-3D illustrate the operation of the embodiment of the wire explosion assembly 101 illustrated in FIGS. 2A-2B to form nanoparticles. The cover 119 is omitted in FIGS. 3A-3D for clarity. In operation, the motor 163 is actuated to rotate (arrow 112) the wire clamping assembly 109 in the wire explosion chamber 108. As illustrated in FIG. 3A, when the wire clamping assembly 109 is in an initial position, the electrically conductive wire 115 extends into the wire explosion chamber 108 through the inlet conduit 126 and the inlet opening 124, extends around a portion of the wire feed guide 128, and is clamped between the clamp 155 of the first clamp assembly 130 and the first wire guide 132 on the winding and tensioning member 129 (i.e., the first clamp assembly 130 is in the clamped position such that the electrically conductive wire 115 is clamped (e.g., secured) between the clamp 155 of the first clamp assembly 130 and the first wire guide 132).

As illustrated in FIG. 3B, the rotation (arrow 112) of the wire clamping assembly 109 causes an additional length of the electrically conductive wire 115 to be withdrawn from the spool 114 and to extend into the wire explosion chamber 108 (i.e., because the electrically conductive wire 115 is clamped between the first clamp assembly 130 and the first wire guide 132, the rotation (arrow 112) of the wire clamping assembly 109 draws more of the electrically conductive wire 115 into the wire explosion chamber 108). When the wire clamping assembly 109 is in the angular position illustrated in FIG. 3B, the electrically conductive wire 115 extends from the first wire guide 132 at the first clamp assembly 130 to the second wire guide 133, which is between the first and second clamp assemblies 130, 131, such that the electrically conductive wire 115 is wound around a portion of the winding and tensioning member 129 (e.g., the electrically conductive wire 115 extends from the first wire guide 132 at the first clamp assembly 130 to the intermediate wire guide 133 between first and second clamp assemblies 130, 131). Additionally, as illustrated in FIG. 3B, as the wire clamping assembly 109 is rotating (arrow 112) inside the wire explosion chamber 108, the rollers of the clamp assemblies 130, 131 engage (e.g., roll or slide) along the cam surface 161 of the cam 121. When the wire clamping assembly 109 is in the angular position illustrated in FIG. 3B, the roller 153 of the second clamp assembly 131 engages the lobe 162 of the cam 121. The engagement between the lobe 162 and the roller 153 of the second clamp assembly 131 causes the lever 151 and the clamp 155 coupled to the lower end 156 of the lever 151 to rotate (arrow 160) into the disengaged position. When the lever 151 and the clamp 155 of the second clamp assembly 131 are in the disengaged position, the clamp 155 is spaced apart from the third wire guide 134 (i.e., the corresponding wire guide 134) on the winding and tensioning member 129. In the illustrated embodiment, the lobe 162 is positioned on the cam 121 such that as the wire clamping assembly 109 rotates (arrow 112), the roller 153 on the second clamp assembly 131 contacts the lobe 162 on the cam 121 before reaching the inlet opening 124. Accordingly, the second clamp assembly 131 is moved (arrow 160) into the disengaged position before reaching the inlet opening 124, which permits the second clamp assembly 131 to pass over the wire feed guide 128 as the wire clamping assembly 109 continues to rotate (arrow 112).

As illustrated in FIG. 3C, as the wire clamping assembly 109 continues to rotate (arrow 112), the wire clamping assembly 109 continues to draw more of the electrically conductive wire 115 into the wire explosion chamber 108 and to wind the electrically conductive wire 115 around a greater portion of the winding and tensioning member 129. When the wire clamping assembly 109 is in the angular position illustrated in FIG. 3C, the electrically conductive wire 115 extends from the first wire guide 132 at the first clamp assembly 130, around the second wire guide 133 between the first and second clamp assemblies 130, 131, and to the third wire guide 134 at the second clamp assembly 131.

Additionally, as the wire clamping assembly 109 is rotated (arrow 112) into the angular position illustrated in FIG. 3D, the roller 153 on the second clamp assembly 131 disengages the lobe 162 on the cam 121 (i.e., the roller 153 rotates past the lobe 162 on the cam 121). Accordingly, the resilient member 159 (e.g., the spring) forces the second clamp assembly 131 to return to the clamped position.

When the second clamp assembly 131 is returned to the clamped position, as illustrated in FIG. 3D, a segment of the electrically conductive wire 115 extends between the first and third wire guides 132, 134 that are coupled to the winding and tensioning member 129 and aligned with the clamp assemblies 130, 131 (e.g., a segment of the electrically conductive wire 115 extends between the first wire guides 132 at the first clamp assembly 130 and the third wire guide 134 at the second clamp assembly 131). Additionally, opposite ends the segment of wire 115 are engaged by the clamps 155 of the first and second clamp assemblies 130, 131. When the wire clamping assembly 109 is in the position illustrated in FIG. 3D, the brush 182 connected to the power source 113 is in contact with the first semi-annular component 180′ of the slip ring 180, but not the second semi-annular component 180″ of the slip ring 180 (see FIG. 2A). Accordingly, when the wire clamping assembly 109 is in the position illustrated in FIG. 3D, current flows from the power source 113 and through the electrical wire 184 coupled to the first semi-annular component 180′ of the slip ring 180. Additionally, because the brush 182 is not in contact with the semi-annular component 180″ of the slip ring 180, current does not flow through the electrical wire 185 coupled to the second semi-annular component 180″ of the slip ring 180. Thus, when the second clamp assembly 131 is returned to the clamped position such that the first and second clamp assemblies 130, 131 are both in the clamped position, as illustrated in FIG. 3D, current flows through the electrical wire 184 coupled to the first clamp assembly 130, through the first clamp assembly 130, through the electrical wire 186 and the second wire guide 133 that is located between the clamp assemblies 130, 131, and through the segment of the electrically conductive wire 115 extending between the first clamp assembly 130 and second wire guide 133 (e.g., the current flows to the segment of the electrically conductive wire 115 through the clamp 155 of the first clamp assembly 130 and the second wire guide 133, which are in contact with opposite ends of the electrically conductive wire 115 segment). The current flowing through the segment of the electrically conductive wire 115 extending between the first clamp assembly 130 and the second wire guide 133 is configured to explode the segment of the electrically conductive wire 115. The size and shape of the winding and tensioning member 129 and the positioning of the clamp assemblies 130, 131 and the wire guides 132-135 on the winding and tensioning member 129 may be selected depending on the desired length of the segment of the electrically conductive wire 115 that is exploded during each wire explosion operation. The portion or segment of the electrically conductive wire 115 between the second wire guide 133 and the second clamp assembly 131 is not exploded.

The explosion of the segment of the electrically conductive wire 115 between the first clamp assembly 130 and the second wire guide 133 forms a plurality of nanoparticles. In one or more embodiments, the nanoparticles formed by exploding the electrically conductive wire 115 may have a diameter from approximately (about) 5 nanometers (“nm”) to approximately (about) 1000 nm depending, for instance, on the processing conditions under which the electrically conductive wire 115 is exploded. Additionally, although in one or more embodiments the nanoparticles may be spherical or substantially spherical, in one or more embodiments, the nanoparticles may deviate from spherical in one or more dimensions by up to approximately (about) 10%. In one or more embodiments, the nanoparticles may have any suitable shape, such as, for instance, rod-like and/or an arbitrary shape. Additionally, in one or more embodiments, the composition of the nanoparticles may be the same or substantially the same as the composition of the electrically conductive wire 115 from which the nanoparticles were formed. In one or more embodiments, vaporization of lighter elements may occur during explosion of the electrically conductive wire 115 and therefore the composition of the nanoparticles may vary from the composition of the electrically conductive wire 115. Additionally, the composition of the nanoparticles may vary depending on the type of processing gas introduced. For instance, the composition of the nanoparticles may vary from the composition of the electrically conductive wire 115 due to the absorption and/or other reaction with one or more elements in the processing gas. For instance, in one or more embodiments, the processing gas may include oxygen to form oxide nanoparticles and/or nitrogen to form nitride nanoparticles.

Additionally, as illustrated in FIG. 3D, following the explosion of the segment of the electrically conductive wire 115, the wire clamping assembly 109 is in the same or substantially the same angular position as the wire clamping assembly 109 was when it was in the initial angular position illustrated in FIG. 3A, but with the positions of the first and second clamp assemblies 130, 131 swapped. Accordingly, the continued rotation (arrow 112) of the wire clamping assembly 109 within the wire explosion chamber 108 is configured to explode additional segments of the electrically conductive wire 115 into nanoparticles in the same manner described above. Accordingly, the continued rotation (arrow 112) of the wire clamping assembly 109 is configured to continuously or substantially continuously form nanoparticles by exploding successive segments of the electrically conductive wire 115. As described above, one of the slip rings 180 is a split ring that includes two semi-annular components 180′, 180″ and therefore the brush 182 connected to the power source 113 alternates between being in contact with the first semi-annular component 180′ and the second semi-annular component 180″ as the wire clamping assembly 109 rotates (arrow 112). Accordingly, current alternately flows through the electrical wire 184 coupled to the first clamp assembly 130 and the electrical wire 185 coupled to the second clamp assembly 131 as the wire clamping assembly 109 rotates (arrow 112). In this manner, the system 100 is configured to alternately explode a segment of the electrically conductive wire 115 extending between the first clamp assembly 130 and the second wire guide 133 and a segment of the electrically conductive wire 115 extending between the second clamp assembly 131 and the fourth wire guide 135. Additionally, the continued rotation (arrow 112) of the wire clamping assembly 109 is configured to apply a consistent or substantially consistent tension on the segment of the electrically conductive wire 115 exploded during each of the wire explosion processes, which is configured to aid in the formation uniform or substantially uniform nanoparticles (i.e., the nanoparticles formed during one wire explosion process using the wire explosion assembly 101 of the present disclosure will have the same or substantially the same characteristics, such as size and/or shape, as nanoparticles formed during a subsequent wire explosion process using the wire explosion assembly 101 of the present disclosure).

In the illustrated embodiment, the conductive wire 115 is redundantly clamped between the clamps 155 of the clamp assemblies 130, 131. For instance, in the illustrated embodiment, the portion of the conductive wire 115 extending between one of the clamp assemblies 130 or 131 and one of the wire guide 133 or 135 is exploded during the wire explosion operation and the other portion of the conductive wire 115 extending between the wire guide 133 or 135 and the other clamp assembly 130 or 131 is not exploded during the wire explosion operation (e.g., only a portion of the segment of the conductive wire 115 extending between the two clamp assemblies 130, 131 is exploded during a single wire explosion operation). Accordingly, once a portion of the conductive wire 115 has been exploded into the nanoparticles, another portion of the conductive wire 115 remains clamped by one of the clamp assemblies 130, 131 (e.g., the end portion of the conductive wire 115 following a wire explosion operation remains secured by one of the clamp assemblies 130, 131). In one or more embodiments, the wire clamping assembly 109 may contain any other suitable number of clamp assemblies 130, 131, such as, for instance, three or more clamp assemblies.

While this invention has been described in detail with particular references to embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention. Additionally, although relative terms such as “horizontal,” “vertical,” “upper,” “lower,” and similar terms have been used herein to describe a spatial relationship of one element to another, it is understood that these terms are intended to encompass different orientations of the various elements and components of the invention in addition to the orientation depicted in the figures. Additionally, as used herein, the term “substantially,” “about,” and similar terms are used as terms of approximation and not as terms of degree, and are intended to account for the inherent deviations in measured or calculated values that would be recognized by those of ordinary skill in the art. Furthermore, as used herein, when a component is referred to as being “on” or “coupled to” another component, it can be directly on or attached to the other component or intervening components may be present therebetween.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. Additionally, the system and/or any other relevant devices or components according to embodiments of the present invention described herein may be implemented utilizing any suitable hardware, firmware (e.g. an application-specific integrated circuit), software, or a combination of software, firmware, and hardware.

What is claimed is:

1. A wire explosion assembly configured to form nanoparticles by exploding at least a segment of an electrically conductive wire, the wire explosion assembly comprising:
a spool supporting the electrically conductive wire;
a vessel defining a wire explosion chamber;
means in the wire explosion chamber for pulling the electrically conductive wire off of the spool and applying tension on the segment of the electrically conductive wire; and
a power source for delivering an electrical current to the segment of the electrically conductive wire, the electrical current configured to explode the segment of the electrically conductive wire into the nanoparticles.

2. The wire explosion assembly of claim 1, wherein the means for pulling and applying tension on the segment of the electrically conductive wire comprise a wire clamping assembly rotatably housed in the wire explosion chamber, the wire clamping assembly comprising:
a winding and tensioning member;
at least first and second clamp assemblies coupled to the winding and tensioning member; and
a wire guide coupled to the winding and tensioning member between the at least first and second clamp assemblies, the at least first and second clamp assemblies each configured to move between a clamped position and a disengaged position,
wherein rotation of the wire clamping assembly is configured to pull the segment of the electrically conductive wire into the wire explosion chamber and wind the segment of the electrically conductive wire around at least a portion of winding and tensioning member to apply the tension to the segment of the electrically conductive wire, and
wherein, when the at least first and second clamp assemblies are in the clamped position, the segment of the electrically conductive wire extends between the wire guide and one of the at least first and second clamp assemblies.

3. The wire explosion assembly of claim 2, further comprising:
a first electrical wire coupled to the first clamp assembly;
a second electrical wire coupled to the second clamp assembly; and
a third electrical wire coupled to the wire guide,
wherein the power source is coupled to the first and second electrical wires, and
wherein the power source is configured to alternately deliver the current through the first and second clamp assemblies to the segment of the electrically conductive wire to explode the segment of the electrically conductive wire into the nanoparticles.

4. The wire explosion chamber of claim 3, wherein the first and second electrical wires each have a first polarity and the third electrical wire has a second polarity opposite the first polarity.

5. The wire explosion assembly of claim 2, further comprising a motor coupled to the wire clamping assembly, the motor configured to rotate the wire clamping assembly in the wire explosion chamber.

6. The wire explosion assembly of claim 2, wherein:
the vessel comprises an inwardly-facing cam surface having at least one lobe; and
the first and second clamp assemblies each further comprise a roller engaging the cam surface, the engagement between the rollers and the at least one lobe on the cam surface of the vessel is configured to alternately move the first and second clamp assemblies into the disengaged position.

7. The wire explosion assembly of claim 6, further comprising:
an inlet opening defined in the vessel, the inlet opening configured to receive the electrically conductive wire extending into the wire explosion chamber; and
a wire feed guide housed in the wire explosion chamber, the wire feed guide configured to align the electrically conductive wire with the wire clamping assembly.

8. The wire explosion assembly of claim 7, wherein the at least one lobe on the inwardly-facing cam surface is positioned proximate to the inlet opening and the wire feed guide, and wherein during the rotation of the wire clamping assembly, the first and second clamping assemblies engage the at least one lobe before reaching the inlet opening.

9. The wire explosion assembly of claim 2, wherein each of the first and second clamp assemblies further comprises a resilient member configured to bias a respective one of the first and second clamp assemblies into the clamped position.

10. The wire explosion assembly of claim 2, wherein the wire guide is a first wire guide, and wherein the wire clamping assembly further comprises a second wire guide coupled to the winding and tensioning member, the second wire guide located between the first and second clamp assemblies and opposite the first wire guide.

11. The wire explosion assembly of claim 2, wherein the winding and tensioning member comprises an electrically non-conductive material.

12. A system configured to form a nanoparticle suspension, the system comprising:
a wire explosion assembly configured to form nanoparticles by exploding at least a segment of an electrically conductive wire, the wire explosion assembly comprising:
a spool supporting the electrically conductive wire;
a vessel defining a wire explosion chamber;
means in the wire explosion chamber for pulling the electrically conductive wire off of the spool and applying tension on the segment of the electrically conductive wire; and
a power source for delivering an electrical current to the segment of the electrically conductive wire, the electrical current configured to explode the segment of the electrically conductive wire into the nanoparticles;
a gas flow system configured to introduce a first processing gas into the wire explosion chamber.

13. The system of claim 12, wherein the first processing gas is oxygen and/or nitrogen.

14. The system of claim 12, wherein the first processing gas is argon.

15. The system of claim 12, further comprising a liquid in the wire explosion chamber, and wherein the means for pulling and applying tension on the segment of the electrically conductive wire is submerged in the liquid such that the nanoparticles are formed in the liquid.

16. The system of claim 12, further comprising a bubbler system coupled to the wire explosion assembly and configured to introduce a solvent to the nanoparticles to form the nanoparticle suspension.

17. The system of claim 16, further comprising a post-processing apparatus positioned between the wire explosion assembly and the bubbler system.

18. The system of claim 17, wherein the post-processing apparatus is configured to introduce a second processing gas different than the first processing gas.

19. The system of claim 17, wherein the post-processing apparatus is configured to process the nanoparticles, the process being at least one process selected from the group consisting of process of heating the nanoparticles, process of cooling the nanoparticles, process of exposing the nanoparticles to an electromagnetic field, process of exposing the nanoparticles to radiation, process of increasing a pressure on the nanoparticles, and process of decreasing a pressure on the nanoparticles.

20. A method of forming nanoparticles, comprising:
pulling a segment of an electrically conductive wire into a wire explosion chamber;
applying a substantially constant tension to the segment of the electrically conductive wire; and
delivering an electrical current to the segment of the electrically conductive wire while applying the substantially constant tension to the segment of the electrically conductive wire to form the nanoparticles.
